(19) United States
(12) Patent Application Publication
(10) Pub. No.: US 2024/0310171 A1
(43) Pub. Date: Sep. 19, 2024

(54) METHOD AND SYSTEM FOR OBSTRUCTION DETECTION ON A ROOF SURFACE

(71) Applicant: Arka Energy Inc., Union City, CA (US)

(72) Inventors: NIKHIL SHAJI, Kottayam (IN); VEDHAGNANAM MOORTHY BARNABAS, Chidambaram (IN)

(21) Appl. No.: 18/603,290

(22) Filed: Mar. 13, 2024

(30) Foreign Application Priority Data
Mar. 13, 2023 (IN) 202311016692

(51) Int. Cl. G01C 11/04; G06V 10/26; G06V 10/764; G06V 20/10

(52) U.S. Cl. CPC G01C 11/04; G06V 10/273; G06V 10/764; G06V 20/176

(57) ABSTRACT

Embodiments of present disclosure relate to a system (100) and a method (400) for detecting obstructions on a roof surface using a set of 3D points that are used for a range of applications. The method involves applying a Random Sample Consensus (RANSAC) mechanism to scatter the received set of 3D points, followed by a planar segmentation technique to exclude the points lying in a plane of the roof surface and obtain obstruction points. The obstruction points are then clustered to recreate obstructions on the roof surface, and a distance check is initiated to group the points and store them as a cluster. The clustering process is repeated with non-clustered points until all points are clustered, and the extracted height and tilt data of clustered points are utilized to create obstructions.

### TECHNICAL FIELD

The present disclosure, in general, relates to obstructions detection. More particularly, it relates to a method and system for detecting obstructions on a roof surface.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

Several techniques have been developed to detect obstructions on a roof surface using 3D point cloud data. One of the commonly used techniques is plane fitting, which involves fitting a plane model to the point cloud data and identifying points that do not lie in the plane. However, this method can produce false positives if the roof surface is not completely planar or if there are irregularities in the surface.

Another technique is clustering, which involves grouping the points that are close to each other and defining them as obstructions. However, this method can result in over-segmentation or under-segmentation of the point cloud data.

There is, therefore, a need to overcome the above drawback, limitations, and shortcomings associated with the existing modeling techniques by providing a solution to detecting obstructions on a roof surface accurately.

### OBJECTS OF THE PRESENT DISCLOSURE

Some of the objects of the present disclosure, which at least one embodiment herein satisfy are as listed herein below.

A general object of present disclosure is to overcome the above drawback, limitations, and shortcomings associated with the existing modeling technique by providing a solution that applies RANSAC and planar segmentation algorithms to accurately detect location and extent of obstructions on a roof, such as chimneys, skylights, and other objects. This helps to identify areas where solar panels cannot be installed, allowing for precise planning and optimization of the solar installation.

Another object of the present disclosure is to provide a system and method to detect obstructions quickly and efficiently, which can save time and resources during the installation process.

Another object of the present disclosure is to provide a system and method for accurately detecting obstructions, use of RANSAC, and planar segmentation to reduce risk of damage to solar panels due to shading or other obstructions. This helps to ensure that the solar installation will perform optimally for its expected lifespan.

Another object of the present disclosure is to provide a system and method for detection of obstructions accurately and efficiently, these algorithms can help to reduce the overall cost of a solar installation project. This is because the cost of installation and maintenance is directly related to the size and complexity of the installation, which can be minimized by avoiding obstructions.

Another object of the present disclosure is to provide a system and method to detect and avoid obstructions, thus solar panels produce more energy, which leads to increased energy production and cost savings over the lifetime of the installation.

### SUMMARY

Various aspects of present disclosure relates to obstructions detection. More particularly, it relates to a method and system for detecting obstructions on a roof surface.

An aspect of present disclosure pertains to a method for detecting one or more obstructions on a roof surface, the method includes receiving a set of 3D points, performing, a Random Sample Consensus (RANSAC) mechanism to scatter the received set of 3D points, applying a planar segmentation technique to exclude the points from the set of 3D points which lies in a plane of the roof surface, and obtaining obstruction points from the set of 3D points, clustering the obstruction points to recreate obstructions, wherein the obstruction points belong to at least one of one or more obstructions on the roof surface, initiating with a random point from the obstruction points and checking distance with the remaining obstruction points, and upon detection of the distance lesser than a threshold value and the clustered obstruction points, checking the distance of non-clustered points and the nearest point from the set of 3D points. Additionally, the method includes grouping the points upon detection of the distance below the threshold value, repeating the grouping of the points until new points added, and storing the points as a cluster, further repeating the clustering with the non-clustered points for clustering of each point the set of 3D points, and utilizing the clustered points to create obstructions by extracting height and tilt.

According to another aspect of present disclosure, a system to detect one or more obstructions on a roof surface is disclosed, the system includes a processor configured to receive a set of 3D points and performs a Random Sample Consensus (RANSAC) mechanism to scatter the received set of 3D points, apply a planar segmentation technique to exclude the points from the set of 3D points which lies in a plane of the roof surface, and obtain obstruction points from the set of 3D points. Additionally, the processor cluster the obstruction points to recreate obstructions, wherein the obstruction points belong to at least one of one or more obstructions on the roof surface, initiate with a random point from the obstruction points and checking distance with the remaining obstruction points, and upon detection of the distance lesser than a threshold value and the clustered obstruction points, checking the distance of non-clustered points and the nearest point from the set of 3D points. Further, the processor group the points, upon detection of the distance below the threshold value, repeat the group process of the points until new points are added, store the points as a cluster, and repeat the clustering with the non-clustered points for clustering of each point the set of 3D points, and utilize the clustered points to create obstructions by extracting height and tilt.

Various objects, features, aspects, and advantages of the present disclosure will become more apparent from the following detailed description of preferred embodiments, along with the accompanying drawing figures in which like numerals represent like features.

### BRIEF DESCRIPTION OF THE ACCOMPANYING DRAWINGS

The accompanying drawings are included to provide a further understanding of the present disclosure, are incorporated in, and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates a block diagram of a system to detect obstructions on a roof surface, in accordance with an embodiment of the present disclosure.

FIG. 2 illustrates exemplary functional components of a processing engine of the system, in accordance with an embodiment of the present disclosure.

FIG. 3 illustrates a method for detecting obstructions on a roof surface, in accordance with an embodiment of the present disclosure.

FIG. 4 illustrates a flow chart of a process for detecting obstructions on a roof surface, in accordance with an embodiment of the present disclosure.

FIG. 5 illustrates an exemplary computer system to implement proposed system, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims. Embodiments of present disclosure relates to obstructions detection. More particularly, it relates to a method and system for detecting obstructions on a roof surface.

An embodiment of present disclosure pertains to a method for detecting one or more obstructions on a roof surface, the method includes receiving a set of 3D points, performing, a Random Sample Consensus (RANSAC) mechanism to scatter the received set of 3D points, applying a planar segmentation technique to exclude the points from the set of 3D points which lies in a plane of the roof surface, and obtaining obstruction points from the set of 3D points, clustering the obstruction points to recreate obstructions, wherein the obstruction points belong to at least one of one or more obstructions on the roof surface, initiating with a random point from the obstruction points and checking distance with the remaining obstruction points, and upon detection of the distance lesser than a threshold value and the clustered obstruction points, checking the distance of non-clustered points and the nearest point from the set of 3D points. Additionally, the method includes grouping the points upon detection of the distance below the threshold value, repeating the grouping of the points until new points added, and storing the points as a cluster, further repeating the clustering with the non-clustered points for clustering of each point the set of 3D points, and utilizing the clustered points to create obstructions by extracting height and tilt.

Another embodiment of present disclosure relates to a system to detect one or more obstructions on a roof surface, the system includes a processor configured to receive a set of 3D points and performs a Random Sample Consensus (RANSAC) mechanism to scatter the received set of 3D points, apply a planar segmentation technique to exclude the points from the set of 3D points which lies in a plane of the roof surface, and obtain obstruction points from the set of 3D points. Additionally, the processor cluster the obstruction points to recreate obstructions, wherein the obstruction points belong to at least one of one or more obstructions on the roof surface, initiate with a random point from the obstruction points and checking distance with the remaining obstruction points, and upon detection of the distance lesser than a threshold value and the clustered obstruction points, checking the distance of non-clustered points and the nearest point from the set of 3D points. Further, the processor group the points, upon detection of the distance below the threshold value, repeat the group process of the points until new points are added, store the points as a cluster, and repeat the clustering with the non-clustered points for clustering of each point the set of 3D points, and utilize the clustered points to create obstructions by extracting height and tilt.

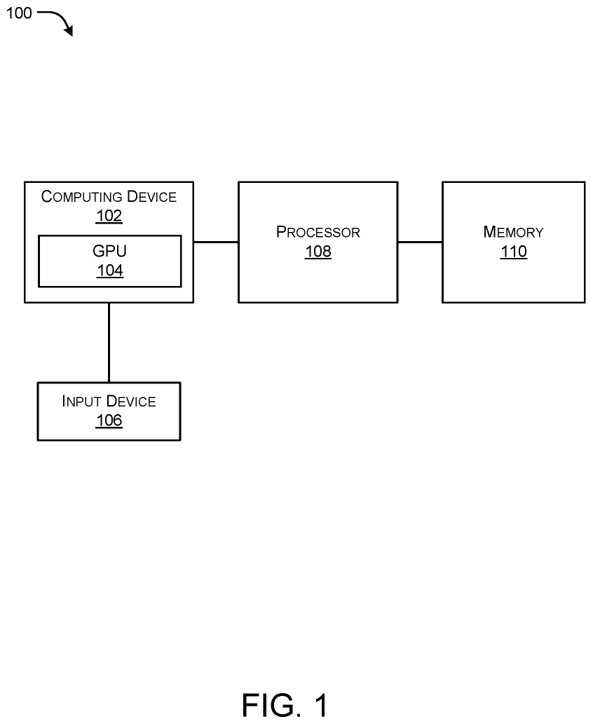

FIG. 1 illustrates a block diagram of a system to detect obstructions on a roof surface, in accordance with an embodiment of the present disclosure.

As illustrated, a system 100 to detect obstructions on a roof surface a region of interest (ROI) in a geographical location is disclosed. The geographical area can be a city that includes both buildings and terrain. The ROI can be roof of any structure such as the building. As used herein, “building” means any manmade structure such as houses, office buildings, storage tanks, warehouses, sports arenas, or the like. The system 100 includes a computing device 102 having a graphical processing unit (GPU) 104, and the computing device 102 can be operatively coupled to an input device 106. The computing device 102 may correspond to various types of computing devices, such as, but not limited to, a desktop computer, a laptop, a PDA, a mobile device, a smartphone, a tablet computer, and the like. The input device 106 may be selected from a group consisting of a mouse, keyboard, a joystick, or the like. The graphical processing unit (GPU) 104 acts as a processing unit for all graphical user interfaces (GUI) in the computing device. In an exemplary embodiment, the GPU 104 renders graphics data inside the GUI and ensures that graphical data is displayed to the computing device 102. In addition, the GPU can be used for memory-intensive tasks like rendering images and videos, animations, and CAD tasks.

In an embodiment, the system 100 includes a processor 108 that can be communicatively coupled to the computing device 102, and a memory 110. The processor 108 includes suitable logic, circuitry, and/or interfaces that are operable to execute one or more instructions stored in the memory 110 to perform pre-determined operation of the system. The memory 110 may be operable to store the one or more instructions. The processor 108 may be implemented using one or more processor technologies known in the art. Examples of the processor 108 include but are not limited to, an x86 processor, a RISC processor, an ASIC processor, a CISC processor, an Arduino Uno board, an ESP 8266 node microcontroller, or any other processor.

The memory 110 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the memory 110 includes the one or more instructions that are executable by the processor 108 to perform specific operations. It will be apparent to a person having ordinary skill in the art that the one or more instructions stored in the memory 110 enable multiple components of the system 100 to perform predetermined operations.

In an embodiment a set of 3D points may be stored on a server (not shown), a set of 3D points of a roof surface that can be extracted from images. The set of 3D points includes any of a LIDAR data and aerial photogrammetry data. The server can be communicatively coupled to the processor through a network (not shown). The network corresponds to a medium through which content and messages flow between various devices of the system 100 (e.g., computing device 102, the server). Examples of the network may include, but are not limited to, a Wireless Fidelity (Wi-Fi) network, a Wide Area Network (WAN), a Local Area Network (LAN), or a Metropolitan Area Network (MAN). Various devices in the system 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

In an embodiment, the server may receive a query from the computing device 102 for retrieving various point cloud data stored in the server. For querying the server, one or more querying languages may be utilized such as, but not limited to, SQL, QUEL, DMX and so forth. Further, the server may be realized through various technologies such as, but not limited to, Microsoft® SQL server, Oracle, and My SQL. In an embodiment, the server may connect to the computing device 102 using one or more protocols such as, but not limited to, ODBC protocol and JDBC protocol.

In an embodiment, the processor 108 may be configured to receive the set of 3D points stored on the server or from an image of the roof surface in the ROI, and determine to perform a Random Sample Consensus (RANSAC) mechanism to scatter the received set of 3D points. When the scattering of the set of 3D points is done, the processor 108 applies a planar segmentation technique to exclude the points from the set of 3D points, which lies in a plane of the roof surface, and obtain obstruction points from the set of 3D points. The planar segmentation technique fits a plane model to the set of 3D points using a plane detection algorithm.

Additionally, the processor 108 clusters the obstruction points to recreate obstructions, and the obstruction points belong to at least one of one or more obstructions on the roof surface. Further, the processor 108 initiates with a random point from the obstruction points and checks distance with the remaining obstruction points. Upon detection of the distance lesser than a threshold value and the clustered obstruction points, checking the distance of non-clustered points and the nearest point from the set of 3D points.

Finally, group of points being done, upon detection of the distance below the threshold value, repeat the group process of the points until new points are added, and store the points as a cluster. Further, repeat, the clustering with the non-clustered points for clustering of each point the set of 3D points, and utilize the clustered points to create obstructions by extracting height and tilt. Thus, the proposed system identifies obstructions on roof surface and extracts height and tilt of the identified obstruction, and correspondingly a 3D model of the roof surface with the obstructions o the roof surface can be generated accurately.

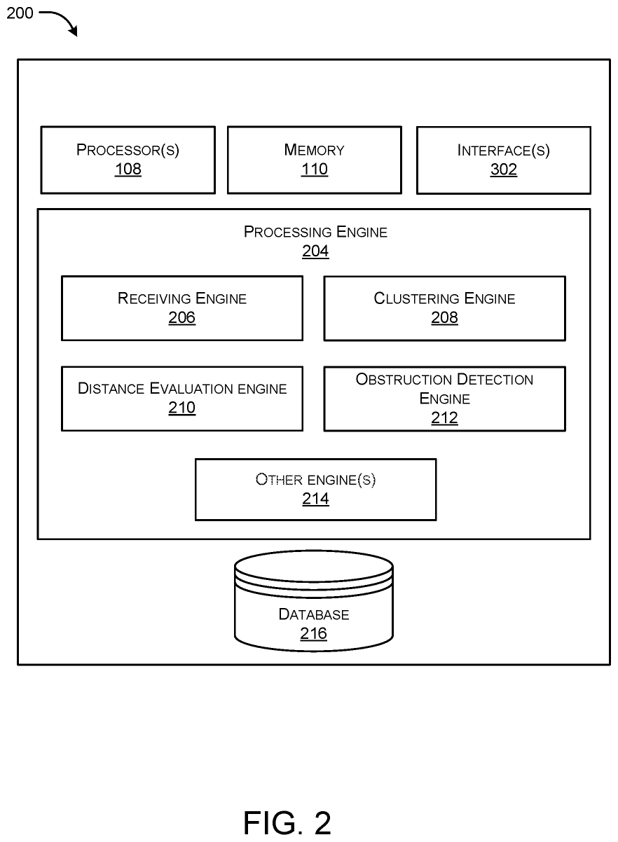

FIG. 2 illustrates exemplary functional components of a processing engine of the system, in accordance with an embodiment of the present disclosure.

In an embodiment, a system 100 includes a processor 108, a memory 110, and one or more interface(s) 202. The interface 202 may include a variety of interfaces, for example, interfaces for data input and output devices, referred to as I/O devices, storage devices, and the like. The interface 202 may also provide a communication pathway for one or more components of system 100. Examples of such components include, but are not limited to, a processing engine 204 and a database 216.

The processing engine 204 is provided with the processor 108, and it can be implemented as a combination of hardware and programming (for example, programmable instructions) to implement one or more functionalities of the processing engine 204. In examples described herein, such combinations of hardware and programming may be implemented in several different ways. For example, the programming for the processing engine 204 may be processing unit executable instructions stored on a non-transitory machine-readable storage medium, and the hardware for the processing engine 204 may include a processing resource (for example, one or more processors), to execute such instructions. In the present examples, the machine-readable storage medium may store instructions that, when executed by the processing resource, implement the processing engine 204. In such examples, the processing engine 204 can include the machine-readable storage medium storing the instructions and the processing resource to execute the instructions, or the machine-readable storage medium may be separate but accessible to the processor 108 and the processing resource. In other examples, the processing engine 204 can be implemented by electronic circuitry.

In an embodiment, the processing engine 204 includes a receiving engine 206, a clustering engine 208, a distance evaluation engine 210, an obstruction detection engine 212, and other engine(s) 214. The other engine(s) 214 can implement functionalities that supplement applications or functions performed by system 100 or the processing engine 204. It would be appreciated that the modules being described are only exemplary modules and any other modules or sub-modules may be included as part of system 100. These units too may be merged or divided into super-modules or sub-modules as may be configured. In addition, database 216 includes data that is either stored or generated as a result of functionalities implemented by any of the components of system 100.

In an embodiment, the receiving engine 206 may be configured to receive a set of 3D points from a server. The set of 3D points can be LIDAR data and aerial photogrammetry data. In an exemplary embodiment, LiDAR data may have been previously acquired by aerial surveyors, and the received LiDAR data is raw data that has not been processed to isolate points corresponding to a roof surface of a ROI. Accordingly, the received 3D LiDAR data includes data points corresponding to not only the roof surface but obstructions on the roof surface also.

In an embodiment, the clustering engine 208 may be configured to perform a Random Sample Consensus (RANSAC) mechanism to scatter the received set of 3D points, apply a planar segmentation technique to exclude the points from the set of 3D points, which lies in a plane of the roof surface, and obtaining obstruction points from the set of 3D points. Additionally, the clustering engine 208 may be configured to cluster the obstruction points to recreate obstructions, where the obstruction points belong to at least one of one or more obstructions on the roof surface.

In an embodiment, the distance evaluation engine 210 may be configured to initiate with a random point from the obstruction points and check distance with the remaining obstruction points. Upon detection of the distance lesser than a threshold value and the clustered obstruction points, check the distance of non-clustered points and the nearest point from the set of 3D points.

In an embodiment, the obstruction detection engine 212 may be configured to group the points, upon detection of the distance below the threshold value, repeat the grouping of the points until new points added, and store the points as a cluster. Further, the obstruction detection engine 212 repeat the clustering with the non-clustered points for clustering of each point the set of 3D points, and utilize the clustered points to create obstructions by extracting height and tilt accurately, and correspondingly a 3D model of a roof surface with accurate obstructions can be generated.

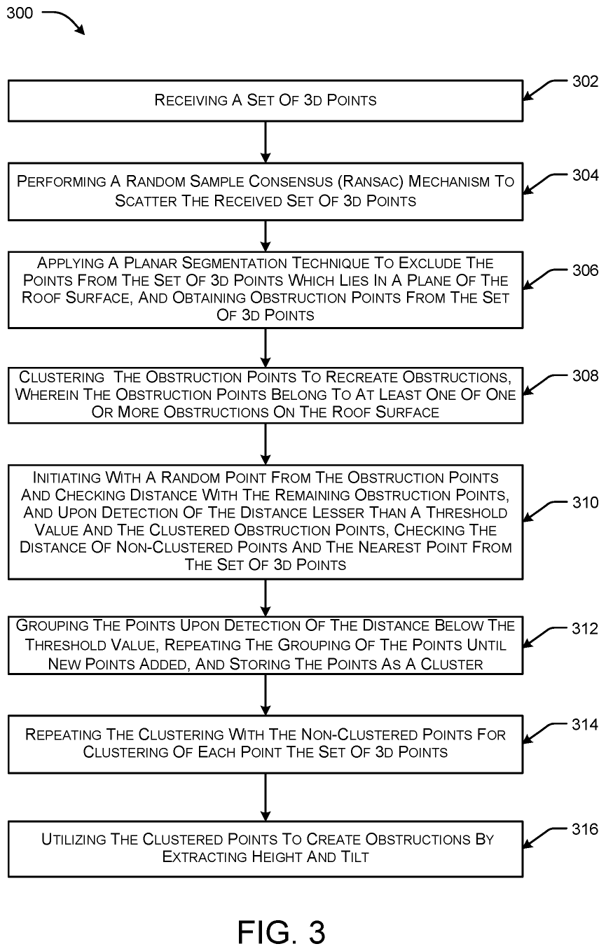

FIG. 3 illustrates a method for detecting obstructions on a roof surface, in accordance with an embodiment of the present disclosure.

As illustrated, at block 302, a method 300 includes receiving, by a processor 108, a set of 3D points.

As illustrated, at block 304, the method 300 includes performing by the processor 108, a Random Sample Consensus (RANSAC) mechanism to scatter the received set of 3D points.

As illustrated, at block 306, the method 300 includes applying by the processor 108, a planar segmentation technique to exclude the points from the set of 3D points that lies in a plane of the roof surface, and obtaining obstruction points from the set of 3D points.

As illustrated, at block 308, the method 300 includes clustering by the processor 108, the obstruction points to recreate obstructions, and the obstruction points belong to at least one of one or more obstructions on the roof surface.

As illustrated, at block 310, the method 300 includes initiating by the processor, with a random point from the obstruction points and checking distance with the remaining obstruction points, and upon detection of the distance lesser than a threshold value and the clustered obstruction points, checking the distance of non-clustered points and the nearest point from the set of 3D points.

As illustrated, at block 312, the method 300 includes grouping the points by the processor, upon detection of the distance below the threshold value, repeating the grouping of the points until new points added, and storing the points as a cluster.

As illustrated, at block 314, the method 300 includes repeating by the processor, the clustering with the non-clustered points for clustering of each point the set of 3D points.

As illustrated, at block 316, the method 300 includes utilizing, by the processor, the clustered points to create obstructions by extracting height and tilt.

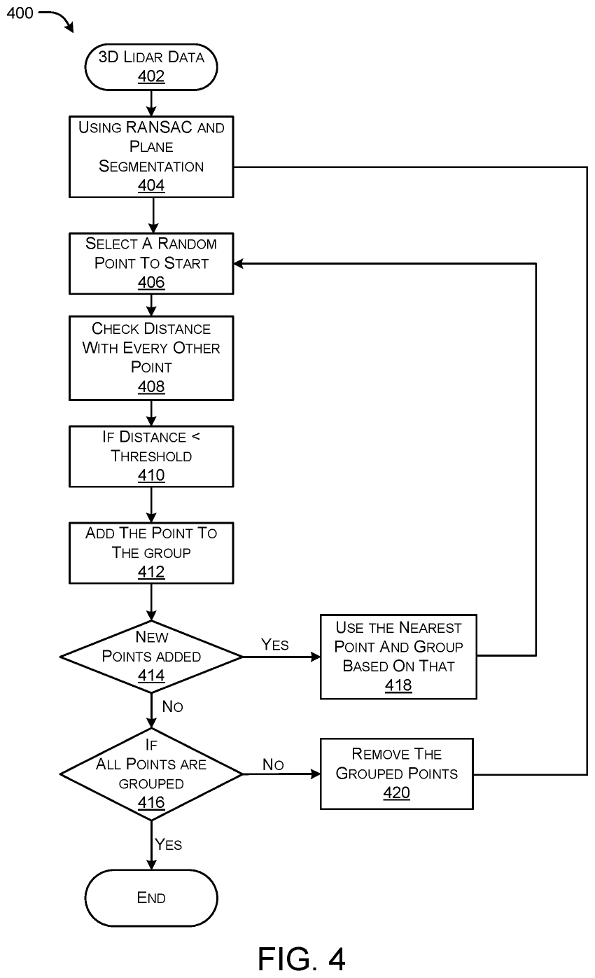

FIG. 4 illustrates a flow chart 400 of a process for detecting obstructions on a roof surface, in accordance with an embodiment of the present disclosure.

As illustrated at step 402, 3D Lidar data (i.e. a set of 3d points) being received, and at step 404, RANSAC mechanism and plane segmentation techniques are applied to the received 3D Lidar data. At step 406, select a random point to start process, and at step 408 check distance of the selected random points with every other points, if distance is less than threshold, as shown in step 410, add point to a group, as shown in step 412. Continuing further, at step 414, check whether new points added or not, when the determination is yes, proceed to step 418, use nearest point and make a group correspondingly, then repeat step 406. However, if the determination is no, proceed to step 416, where it is checked, whether all points are grouped or not, when the determination is yes, the process ends. When determination is no at step 416, remove the grouped points at step 420, and repeat step 408.

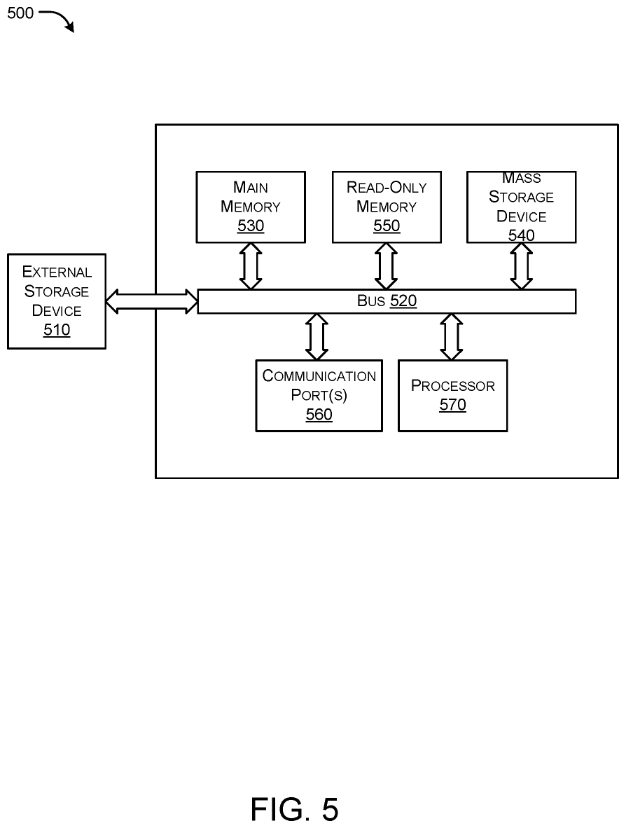

FIG. 5 illustrates an exemplary computer system to implement proposed system, in accordance with an embodiment of the present disclosure. As shown in FIG. 5, a computer system 500 can include an external storage device 510, a bus 520, a main memory 530, a read only memory 540, a mass storage device 550, communication port 560, and a processor 570. A person skilled in the art will appreciate that the computer system may include more than one processor and communication ports. Examples of processor 570 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 570 may include various modules associated with embodiments of the present invention. Communication port 560 can be any of an RS-232 port for use with a modem-based dialup connection, a 10/100 Ethernet port, a Gigabit or 10 Gigabit port using copper or fibre, a serial port, a parallel port, or other existing or future ports. Communication port 560 may be chosen depending on a network, such a Local Area Network (LAN), Wide Area Network (WAN), or any network to which computer system connects. Memory 530 can be Random Access Memory (RAM), or any other dynamic storage device commonly known in the art. Read-only memory 540 can be any static storage device(s) e.g., but not limited to, a Programmable Read Only Memory (PROM) chips for storing static information e.g., start-up or BIOS instructions for processor 570. Mass storage 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 520 communicatively couples processor(s) 570 with the other memory, storage, and communication blocks. Bus 520 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 570 to software system.

Optionally, operator and administrative interfaces, e.g., a display, keyboard, and a cursor control device, may also be coupled to bus 520 to support direct operator interaction with a computer system. Other operator and administrative interfaces can be provided through network connections connected through communication port 560. The external storage device 510 can be any kind of external hard-drives, floppy drives, IOMEGA® Zip Drives, Compact Disc—Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Embodiments disclosed herein provide system and method that applies RANSAC and planar segmentation algorithms to accurately detect location and extent of obstructions on the roof surface, such as chimneys, skylights, and other objects. This helps to identify areas where solar panels cannot be installed, allowing for precise planning and optimization of the solar installation.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced.

Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to those having ordinary skill in the art.

### ADVANTAGES OF THE INVENTION

The present disclosure provides a system and method that applies RANSAC and planar segmentation algorithms to accurately detect location and extent of obstructions on a roof, such as chimneys, skylights, and other objects. This helps to identify areas where solar panels cannot be installed, allowing for precise planning and optimization of the solar installation.

The present disclosure provides a system and method to detect obstructions quickly and efficiently, which can save time and resources during the installation process.

The present disclosure provides a system and method for accurately detecting obstructions, use of RANSAC, and planar segmentation to reduce risk of damage to solar panels due to shading or other obstructions. This helps to ensure that the solar installation will perform optimally for its expected lifespan.

The present disclosure provides a system and method for detection of obstructions accurately and efficiently, these algorithms can help to reduce the overall cost of a solar installation project. This is because the cost of installation and maintenance is directly related to the size and complexity of the installation, which can be minimized by avoiding obstructions.

The present disclosure provides a system and method to detect and avoid obstructions, thus solar panels produce more energy, which leads to increased energy production and cost savings over the lifetime of the installation.

We claim:

1. A method for detecting one or more obstructions on a roof surface, the method comprising:
receiving, by a processor, a set of 3D points;
performing, by the processor, a Random Sample Consensus (RANSAC) mechanism to scatter the received set of 3D points;
applying, by the processor, a planar segmentation technique to exclude the points from the set of 3D points which lies in a plane of the roof surface, and obtaining obstruction points from the set of 3D points;
clustering, by the processor, the obstruction points to recreate obstructions, wherein the obstruction points belong to at least one of one or more obstructions on the roof surface;
initiating, by the processor, with a random point from the obstruction points and checking distance with the remaining obstruction points, wherein upon detection of the distance lesser than a threshold value and the clustered obstruction points, checking the distance of non-clustered points and the nearest point from the set of 3D points;
grouping the points, by the processor, upon detection of the distance below the threshold value, repeating the grouping of the points until new points added, and storing the points as a cluster;
repeating, by the processor, the clustering with the non-clustered points for clustering of each point the set of 3D points; and
utilizing, by the processor, the clustered points to create obstructions by extracting height and tilt.

2. The method as claimed in claim 1, wherein the set of 3D points comprises any of a LIDAR data and aerial photogrammetry data.

3. The method as claimed in claim 1, wherein the set of 3D points are stored on a server, wherein the processor is communicatively coupled to the server by a network.

4. The method as claimed in claim 1, further comprising:
filtering, of the received set of 3D points to remove noise prior to perform RANSAC mechanism.

5. The method of claim 1, wherein the planar segmentation technique fitting a plane model to the set of 3D points using a plane detection algorithm.

6. The method of claim 1, wherein the threshold value for distance is determined based on the size of the obstruction.

7. The method of claim 1, further comprising a machine learning algorithm to classify the extracted height and tilt data into different types of obstructions on the roof surface.

8. A system to detect one or more obstructions on a roof surface, the system comprising:
a processor; and
a memory storing instructions that, when executed by the processor, cause the processor to perform:
receive, a set of 3D points and perform a Random Sample Consensus (RANSAC) mechanism to scatter the received set of 3D points;
apply, a planar segmentation technique to exclude the points from the set of 3D points which lies in a plane of the roof surface, and obtain obstruction points from the set of 3D points;
cluster, the obstruction points to recreate obstructions, wherein the obstruction points belong to at least one of one or more obstructions on the roof surface;
initiate, with a random point from the obstruction points and check distance with the remaining obstruction points, wherein upon detection of the distance lesser than a threshold value and the clustered obstruction points, check the distance of non-clustered points and the nearest point from the set of 3D points;
group, the points, upon detection of the distance below the threshold value, repeat the group process of the points until new points added, and store the points as a cluster; and
repeat, the clustering with the non-clustered points for clustering of each point the set of 3D points, and utilize the clustered points to create obstructions by extracting height and tilt.

9. The system as claimed in claim 8, wherein the set of 3D points comprises any of a LIDAR data and aerial photogrammetry data.

10. The system as claimed in claim 8, wherein the planar segmentation technique fits a plane model to the set of 3D points using a plane detection algorithm.
